(19) United States
(12) Patent Application Publication
(10) Pub. No.: US 2013/0216656 A1
(43) Pub. Date: Aug. 22, 2013

(54) Food Supplement

(71) Applicants: Ambrose Jacob Spinnler Benadé, Bellville (ZA); Maretha Opperman, Bellville (ZA)

(72) Inventors: Ambrose Jacob Spinnler Benadé, Bellville (ZA); Maretha Opperman, Bellville (ZA)

(73) Assignee: CAPE PENINSULA UNIVERSITY OF TECHNOLOGY, Bellville (ZA)

(21) Appl. No.: 13/879,144

(22) PCT Filed: Oct. 14, 2010
(86) PCT No.: PCT/IB2010/054654

§ 371 Date: May 10, 2013

(51) Int. Cl. A23L 1/30; A23L 1/302

(52) U.S. Cl. CPC A23L 1/3002; A23L 1/3008; A23L 1/302
USPC 426/72

(57) ABSTRACT

The invention discloses a food supplement, which includes at least the following components: omega-3 fatty acids; natural carotenoids; natural tocopherol; and tocotrienol. The carotenoids include carotenes. The carotenoids and tocotroniel are obtained from a Carotino mixed concentrate. The Carotino mixed concentrate is a natural tocotrienol (Vitamin E) and carotene oil complex derived from palm fruits.

### FIELD OF INVENTION

The present invention relates to a food supplement.

More particularly, the present invention relates to a food supplement including a spectrum of carotenoids, tocopherol, tocotrienol and Omega-3 fatty acids.

### BACKGROUND TO INVENTION

Food fortification is a public health policy of adding micronutrients (essential trace elements and vitamins) to foodstuffs to ensure that minimum dietary requirements are met. Simple diets based on staple foods with little variation are often deficient in certain nutrients, either because they are not present in sufficient amounts in the soil of a region, or because of the inherent inadequacy of the diet. The addition of micronutrients to staples and condiments can prevent large-scale deficiency diseases in these cases.

Several ranges of food supplements are recognised:
(a) additives which repair a deficit to “normal” levels;
(b) additives which appear to enhance a food; and
(c) supplements taken in addition to the normal diet.

Physicians disagree with the premise that foodstuffs need supplementation, but accept, for example, that added calcium may provide benefit, or that adding folic acid may correct a nutritional deficiency especially in pregnant women.

On a more controversial level is the science of using foods and food supplements to achieve a defined health goal. A common example of this use of food supplements is the extent to which body builders will use amino acid mixtures, vitamins and phytochemicals to enhance natural hormone production, increase muscle and reduce fat.

There is increasing evidence for the use of food supplements in established medical conditions. This nutritional supplementation using foods as medicine (nutraceuticals) has been effectively used in treating disorders affecting the immune system up to and including cancers. This goes beyond the definition of “food supplement”.

There are several main groups of food supplements which can be considered:
(a) Vitamins and co-vitamins;
(b) Essential minerals;
(c) Essential fatty acids;
(d) Essential amino acids;
(e) Glyconutrients; and
(f) Phytonutrients.

Omega-3 fatty acids are considered essential fatty acids and cannot be manufactured in the body and are therefore be obtained from the diet. Omega-3 fatty acids play a crucial role in brain function as well as in normal growth and development. Extensive research indicates that Omega-3 fatty acids reduce inflammation and help prevent risk factors associated with chronic diseases such as heart disease, cancer and arthritis. These essential fatty acids are highly concentrated in the brain and appear to be particularly important for cognitive and behavioural function. Omega-3 fatty acids can be of plant and marine origin.

Symptoms of Omega-3 fatty acid deficiency include extreme tiredness, poor memory, dry skin, heart problems, mood swings or depression, and poor circulation. The American Heart Association recommends eating fatty fish such as mackerel, lake trout, herring, sardines, tuna and salmon at least twice a week to ensure an adequate intake of Omega-3 fatty acids. Current indications suggest an inadequate dietary intake of Omega-3 fatty acids by consumers in industrialized countries. In contrast, however, the Mediterranean diet emphasizes foods rich in Omega-3 fatty acids, fresh fruits, whole grains, vegetables, fish, olive oil, garlic, as well as moderate wine consumption.

Clinical studies suggest that Omega-3 fatty acids may be helpful in treating a variety of health conditions and that it may also reduce the risk for several other disease conditions. The evidence is strongest for heart disease and problems that contribute to heart disease.

Possible uses for Omega-3 fatty acids include:
(a) High cholesterol;
(b) High blood pressure;
(c) Heart disease;
(d) Diabetes—lowering of triglycerides;
(e) Weight loss—better control over blood sugar;
(f) Arthritis—reduction in joint stiffness;
(g) Osteoporosis—increase levels of Calcium and increase bone strength;
(h) Depression;
(i) Attention deficit/hyperactivity disorder—improvement in reading, spelling and behaviour;
(j) Eating disorders—prevention of Omega-3 deficiency;
(k) Skin disorders—treatment of acne;
(l) Macular degeneration—reducing risk;
(m) Breast cancer—reducing risk;
(n) Prostate cancer—reducing the risk;
(o) Improves immune function; and
(p) Aids—prolong survival.

Based on the observation that dietary intake of Omega-3 fatty acids is inadequate, the intake of Omega-3 fatty acids can be increased by supplementation, with a product containing Omega-3 fatty acids.

In a 2002 report, the Institute of Medicine recommended a safe level of EPA and DHA of about 270 mg per day, a figure industry would consider as being at the low end of the spectrum. A more recent National Institutes of Health report recommended 650 mg of EPA and DHA per day. In 2003, the UK Export Group on Vitamins and Minerals (EVM) recommended 450 mg per day.

Carotenoids are organic pigments that are naturally occurring in the chloroplasts and chromoplasts of plants and some other photosynthetic organisms like algae, some types of fungus and some bacteria. There are over 600 known carotenoids; they are split into two classes:
(a) Xanthophylls; and
(b) carotenes.

They absorb blue light. Carotenoids serve two key roles in plants and algae: they absorb light energy for use in photosynthesis, and they protect chlorophyll from photodamage. In humans, carotenoids such as beta-carotene are a precursor to vitamin A, a pigment essential for good vision, and carotenoids can also act as antioxidants.

People consuming diets rich in carotenoids from natural foods, such as fruits and vegetables, are healthier and have lower mortality from a number of chronic illnesses. With the notable exception of Vietnam Gac and crude palm oil, most carotenoid-rich fruits and vegetables are low in lipids.

Alpha- and Beta carotene have the following advantages:
(a) provitamin A activity in humans;
(b) Antioxidant effect;
(c) Singlet oxygen quenching;
(d) Increased in vivo immune response;
(e) Improved cell-to-cell communication;
(f) Carotenes linked to lower heart disease;
(g) Reduction of skin reactions in light dermatoses;
(h) Macula protection from UV light;
(i) Low plasma Beta-carotene concentration is associated with an increased risk of various precancerous diseases and various forms of cancer including prostate cancer;
(j) Low plasma Beta-carotene concentration is associated with an increased risk of cardiovascular disease;
(k) High plasma lycopene concentration is supposed to reduce the risk of prostate cancer; and
(l) Long-term Beta carotene intake may slow mental decline.

Based on the recommendations of the American Heart Foundation of a daily intake of at least five portions of fruit and vegetables per day, it is recommended that the total carotene intake per day should be about 6 mg per person per day.

Vitamin E is the collective name for a set of 8 related α-, β-, γ-, and δ-tocopherols and the corresponding four tocotrienols, which are fat-soluble vitamins with antioxidant properties. Of these, α-tocopherol (also written as alpha-tocopherol) has been most studied as it has the highest bioavailability.

It has been claimed that α-tocopherol is the most important lipid-soluble antioxidant, and that it protects cell membranes from oxidation by reacting with lipid radicals produced in the lipid peroxidation chain reaction. This would remove the free radical intermediates and prevent the oxidation reaction from continuing. The oxidised α-tocopheroxyl radicals produced in this process may be recycled back to the active reduced form through reduction by other antioxidants, such as ascorbate, retinol or ubiquinol. However, the importance of the antioxidant properties of this molecule at the concentrations present in the body are not clear and it is possible that the reason why vitamin E is required in the diet is unrelated to its ability to act as an antioxidant. Other forms of vitamin E have their own unique properties. For example, γ-tocopherol (also written as gamma-tocopherol) is a nucleophile that may react with electrophilic mutagens; and the tocotrienols having specialized roles in protecting neurons from damage, cancer prevention and cholesterol reduction by inhibiting the activity of HMG-CoA reductase[16-1]; δ-tocotrienol blocks processing of sterol regulatory element-binding proteins (SREBPs)[16-1]. However, the roles and importance of all of the various forms of vitamin E are presently unclear, and it has even been suggested that the most important function of vitamin E is as a signaling molecule, and that it has no significant role in antioxidant metabolism.

Tocotrienol and tocopherol compose the vitamin E family. Each of these members exists in four different forms or isomers, named alpha, beta, gamma and delta. All of the isomers have been demonstrated to have some level of antioxidant activity. However, some of the isomers have been further investigated through a number of clinical and non-clinical studies for their biological activities. Some research suggests that tocotrienols are more potent in their anti-oxidant and anti-cancer effect than the common forms of tocopherol due to significant differences in chemical structure.

The advantages of tocotrienols are as follows:
(a) Tocotrienol supplementation may protect against stroke;
(b) Tocotrienol has the ability to reverse arterial blockage of the carotid artery in carotid stenosis patients;
(c) The benefits of tocotrienols range from decreasing platelet aggregation to anti-inflammatory action and anti-cancer activity;
(d) Gamma-tocotrienol is a potent suppressor of prostate cancer cell proliferation;
(e) Gamma and delta tocotrienols were shown to be effective nutritional agents to treat high cholesterol; and
(f) Vitamin E intake is significantly associated with a reduced risk of type 2 diabetes.

Unfortunately the known food supplements available in the market do not contain required combinations of elements or do not contain the required amounts of the elements for adequate health promotion and disease prevention.

It is an object of the invention to suggest a novel food supplement which will assist in overcoming the aforementioned problems.

### SUMMARY OF INVENTION

According to the invention, a food supplement, includes at least the following components:
(a) omega-3 fatty acids;
(b) natural carotenoids;
(c) natural tocopherol; and
(d) tocotrienol.

The food supplement may include no synthetic ingredients.

The component(s) may be of natural origin and of high purity.

The carotenoids may include carotenes.

The carotenoids and tocotrienol may be obtained from a Carotino mixed concentrate.

The Carotino mixed concentrate may be a natural tocotrienol (Vitamin E) and carotene oil complex derived from palm fruits.

The Carotino mixed concentrate may include tocotrienols consisting of alpha-, gamma- and delta-tocotrienols.

The Carotino mixed concentrate may include a spectrum of carotenes, but consist predominantly of alpha- and beta-carotenes.

The Carotino mixed concentrate may include the following percentages:
(a) at least 2.7% carotenoid composition;
(b) at least 9.3% tocopherol and tocotrienol; and
(c) at least 53% palm oil.

The Carotino mixed concentrate may include the following carotenoid content per 100 mg:

| | | | |
|---|---|---|---|
| (a) | Alpha-carotene | 1.01 | mg |
| (b) | Beta-carotene | 1.52 | mg |
| (c) | Gamma-carotene | 91 | mcg |
| (d) | Lycopene | 16 | mcg |
| (e) | Xhanthophylls | 60 | mcg |
| (f) | Other | 0.1 | mg |

The Carotino mixed concentrate may include the following Vitamin E content per 100 mg:

| | | |
|---|---|---|
| (a) | Tocopherols | 1.9 mg |
| (b) | Tocotrienols | 7.4 mg |

The Carotino mixed concentrate may additionally include the following ingredients per 100 mg:

| | | | |
|---|---|---|---|
| (a) | Phytosterols | 1.3 | mg |
| (b) | Squalene | 0.36 | mg |
| (c) | Co-enzyme Q 10 | 67 | mcg |
| (d) | Glycerides | 53 | mg |

The Carotino mixed concentrate may additionally include the following heavy metal content per 100 mg:

| | | |
|---|---|---|
| (a) | Lead | less than 0.6 parts per million |
| (b) | Mercury | less than 0.05 parts per million |
| (c) | Arsenic | less than 0.1 parts per million |

The Carotino mixed concentrate may include the following micro-biological purity:

| | |
|---|---|
| (a) Total plate count, yeast and mold | less than 10 cfu/g |

The food supplement may include marine fish oil.

The food supplement may be provided in a capsule.

The capsule may have a content of 1000 mg.

Each capsule may include the following:

| | | |
|---|---|---|
| (a) | Marine fish oil | 850 mg, range 1 mg-999 mg |
| (b) | Total carotenes | 4.1 mg |
| | a. Alpha-carotene | 1.52 mg: range 30 mcg-30 mg |
| | b. Beta-carotene | 2.3 mg: range 45 mcg-45 mg |
| | c. Other carotenes | 280 mcg: range 7 mcg-7 mg |
| (c) | Vitamin E: | 14.0 mg: range 79 mcg-79 mg |
| | a. Tocopherol | 2.8 mg: range 15 mcg-30 mg |
| | b. Tocotrienols | 11.2 mg: range 64 mcg-100 mg |
| (d) | Other ingredients: | |
| | a. Phytosterols | 1.9 mg: range 38 mcg-38 mg |
| | b. Squalene | 550 mcg: range 11 mcg-11 mg |
| | c. Co-enzyme Q 10 | 200 mcg: range 4 mcg-4 mg |
| | d. Palm oil | 80 mg: range 593 mcg-593 mg |
| (e) | Omega-3 Fatty acids: | 255 mg: range 195 mcg-800 mg |
| | a. Eicosapentaenoic Acid (EPA) | 153 mg: range 100 mcg-800 mg |
| | b. Docosahexanoic Acid (DHA) | 102 mg: range 95 mcg-190 mg |

A daily dose of two 1000 mg capsules of the food supplement containing 300 mg Carotino mixed concentrate may provide:

| | | |
|---|---|---|
| Alpha-carotene | 3.04 | mg |
| Beta-carotene | 4.6 | mg |
| Other carotenes | 0.6 | mg |
| Tocopherol | 5.6 | mg |
| Tocotrienol | 22.4 | mg |
| Phytosterol | 3.9 | mg |
| Squalene | 1.1 | mg |
| Co-enzyme Q 10 | 400 | mcg |
| Eicosapentaenoic Acid (EPA) | 306 | mg |
| Docosahexanoic Acid (DHA) | 204 | mg |

### DETAILED DESCRIPTION OF EXAMPLES

The invention will now be described by way of example.

According to the invention, a food supplement, includes at least the following components:
(a) omega-3 fatty acids;
(b) carotenoids;
(c) natural tocopherol; and
(d) tocotrienol.

The food supplement includes no synthetic ingredients. The components are of natural origin and of high purity.

The carotenoids include carotenes.

The carotenoids and tocotrienol are obtained from a Carotino mixed concentrate. The Carotino mixed concentrate is a natural tocotrienol (Vitamin E) and carotene oil complex derived from palm fruits. The Carotino mixed concentrate includes tocotrienols consisting of alpha-, beta, gamma- and delta-tocotrienols. The Carotino mixed concentrate includes a spectrum of carotenes, but consist predominantly of alpha- and beta-carotenes.

The Carotino mixed concentrate includes the following percentages:
(a) at least 2.7% carotenoid composition;
(b) at least 9.3% tocopherol and tocotrienol; and
(c) at least 53% palm oil.

The Carotino mixed concentrate includes the following carotenoid content per 100 mg:

| | | | |
|---|---|---|---|
| (a) | Alpha-carotene | 1.01 | mg |
| (b) | Beta-carotene | 21.52 | mg |
| (c) | Gamma-carotene | 91 | mcg |
| (d) | Lycopene | 16 | mcg |
| (e) | Xhanthophylls | 60 | mcg |
| (f) | Other | 0.1 | mg |

The Carotino mixed concentrate includes the following Vitamin E content per 100 mg:
(a) Tocopherols 1.9 mg
(b) Tocotrienols 7.4 mg

The Carotino mixed concentrate additionally includes the following ingredients per 100 mg:

| | | | |
|---|---|---|---|
| (a) | Phytosterols | 1.3 | mg |
| (b) | Squalene | 0.4 | mg |
| (c) | Co-enzyme Q 10 | 67 | mcg |
| (d) | Palm oil | 53 | mg |

The Carotino mixed concentrate additionally includes the following heavy metal content per 100 mg:

| | | |
|---|---|---|
| (a) | Lead | less than 0.6 parts per million |
| (b) | Mercury | less than 0.05 parts per million |
| (c) | Arsenic | less than 0.1 parts per million |

The Carotino mixed concentrate includes the following micro-biological purity:

| | |
|---|---|
| (a) Total plate count, yeast and mold | less than 10 cfu/g |

The food supplement includes marine fish oil.

The food supplement is provided in a capsule having a content of 1000 mg.

Each capsule includes the following:

| | | |
|---|---|---|
| (a) | Marine fish oil | 850 mg, range 1 mg-999 mg |
| (b) | Total carotenes | 4.10 mg |
| | a. Alpha-carotene | 1.52 mg: range 30 mcg-30 mg |
| | b. Beta-carotene | 2.3 mg: range 45 mcg-45 mg |
| | c. Other carotenes | 280 mcg: range 7 mcg-7 mg |
| (c) | Vitamin E: | 14.0 mg: range 79 mcg-79 mg |
| | a. Tocopherol | 2.8 mg: range 15 mcg-30 mg |
| | b. Tocotrienols | 11.2 mg: range 64 mcg-64 mg |
| (d) | Other ingredients: | |
| | a. Phytosterols | 1.9 mg: range 38 mcg-38 mg |
| | b. Squalene | 550 mcg: range 11 mcg-11 mg |
| | c. Co-enzyme Q 10 | 200 mcg: range 4 mcg-4 mg |
| | d. Palm oil | 29.3 mg: range 593 mcg-593 mg |
| (e) | Omega-3 Fatty acids: | 255 mg: range 195 mcg-800 mg |
| | a. Eicosapentaenoic Acid (EPA) | 153 mg: range 100 mcg-400 mg |
| | b. Docosahexanoic Acid (DHA) | 102 mg: range 95 mcg-400 mg |

A daily dose of two 1000 mg capsules of the food supplement containing 150 mg Carotino mixed concentrate provides:

| | | |
|---|---|---|
| Alpha-carotene | 3.04 | mg |
| Beta-carotene | 4.6 | mg |
| Other carotenes | 0.6 | mg |
| Tocopherol | 5.6 | mg |
| Tocotrienol | 22.4 | mg |
| Phytosterol | 3.9 | mg |
| Squalene | 1.1 | mg |
| Co-enzyme Q 10 | 400 | mcg |
| Eicosapentaenoic Acid (EPA) | 306 | mg |
| Docosahexanoic Acid (DHA) | 204 | mg |

Although there are many kinds of Omega-3 supplements available on the open market, a recent survey of these products showed that they invariably contain mostly one or two of the components present in the present novel food supplement. No product could be found that contains the spectrum of components present in the new food supplement. A possible explanation for this observation is that the present novel food supplement includes a natural concentrate with a unique composition of Carotenoids, and vitamin E complex consisting of Tocopherol and Tocotrienol. When this concentrate is added to fish oil which is a good source of marine Omega-3 fatty acids, the product so obtained is unique. Although it is theoretically possible to imitate the concentrate in terms of its composition, it will be extremely difficult and expensive which will make it un-affordable.

The food supplement according to the invention includes 255 mg of Omega-3 marine fatty consisting of 102 mg Docosahexanoic acid (DHA) and 153 mg Eicosapentaenoic acid (EPA) per capsule. Each capsule contains 850 mg marine fish oil. The recommended dose will be two capsules per day. Studies currently in progress showed that the Omega-3 fatty acids supplements do indeed increase the levels of these acids in the blood of research participants.

The concentrate of carotenoids used in the food supplement according to the invention contains a spectrum of thirteen different natural carotenes, with alpha- and beta carotene making up approximately 87%-92% of the total carotenes.

An intake of 8.2 mg of carotenes per day was decided upon (2 capsules/day) for the food supplement according to the invention.

The concentrate used as our source for tocopherol and tocotrienol is a natural source containing 81% tocotrienol.

The daily intake of tocopherol and tocotrienol from the two capsules a day are 5.6 mg and 22.4 mg respectively. This food supplement according to the invention is unique insofar that 80% of the vitamin E content is tocotrienol which is almost absent from oils generally used for cooking where the vitamin E is mainly present as tocopherol.

High grade fish oil is sourced from a supply containing between 10% and 20% Eicosapentaenoic Acid (EPA) and between 10% and 14% Docosahexaenoic Acid (DHA). The heavy metal content of the oil is within the legal limits. Capsules contain 1000 mg (1 g) of a mixture of marine oil and Carotino mixed concentrate.

The food supplement according to the invention is unique in the sense that it contains omega-3 fatty acids, carotenes, tocopherol and tocotrienol which combines unique health benefits found in no other product available on the market. It contains no synthetic ingredients and the contents are of natural origin and of high purity.

1. A food supplement, which includes at least the following components:
(a) omega-3 fatty acids;
(b) natural carotenoids;
(c) natural tocopherol; and
(d) tocotrienol.

2. A food supplement as claimed in claim 1, which includes no synthetic ingredients.

3. A food supplement as claimed in claim 1, in which the components are of natural origin and of high purity.

4. A food supplement as claimed in claim 1; in which the carotenoids include carotenes.

5. A food supplement as claimed in claim 1, in which the carotenoids and tocotroniel are obtained from a Carotino mixed concentrate.

6. A food supplement as claimed in claim 5, in which the Carotino mixed concentrate is a natural tocotrienol (Vitamin E) and carotene oil complex derived from palm fruits.

7. A food supplement as claimed in claim 5, in which the Carotino mixed concentrate includes tocotrienols consisting of alpha-, beta-, gamma- and delta-tocotrienols.

8. A food supplement as claimed in claim 5, in which the Carotino mixed concentrate includes a spectrum of carotenes, but consists predominantly of alpha- and beta-carotenes.

9. A food supplement as claimed in claim 5, in which the Carotino mixed concentrate includes the following percentages:
(a) at least 2.7% carotenoid composition;
(b) at least 9.3% tocopherol and tocotrienol; and
(c) at least 53% palm oil.

10. A food supplement as claimed in claim 5, in which the Carotino mixed concentrate includes substantially the following carotenoid content per 100 mg:

| | | | |
|---|---|---|---|
| (a) | Alpha-carotene | 1.01 | mg |
| (b) | Beta-carotene | 1.52 | mg |
| (c) | Gamma-carotene | 91 | mcg |
| (d) | Lycopene | 16 | mcg |
| (e) | Xhanthophylls | 60 | mcg |
| (f) | Other | 0.1 | mg. |

11. A food supplement as claimed in claim 5, in which the Carotino mixed concentrate includes substantially the following Vitamin E content per 100 mg:

| | | |
|---|---|---|
| (a) | Tocopherols | 1.8 mg |
| (b) | Tocotrienols | 7.4 mg. |

12. A food supplement as claimed in claim 11, in which the Carotino mixed concentrate additionally includes substantially the following ingredients per 100 mg:

| | | | |
|---|---|---|---|
| (a) | Phytosterols | 1.3 | mg |
| (b) | Squalene | 0.37 | mg |
| (c) | Co-enzyme Q 10 | 67 | mcg |
| (d) | Palm oil | 53 | mg. |

13. A food supplement as claimed in claim 11, in which the Carotino mixed concentrate additionally includes substantially the following heavy metal content per 100 mg:

| | | |
|---|---|---|
| (a) | Lead | less than 0.6 parts per million |
| (b) | Mercury | less than 0.05 parts per million |
| (c) | Arsenic | less than 0.1 parts per million. |

14. A food supplement as claimed in claim 5, in which the Carotino mixed concentrate includes substantially the following micro-biological purity: Total plate count, yeast and mold less than 10 cfu/g.

15. A food supplement as claimed in claim 1, which includes marine fish oil.

16. A food supplement as claimed in claim 1, which is provided in a capsule.

17. A food supplement as claimed in claim 16, in which the capsule has a content of 1000 mg.

18. A food supplement as claimed in claim 16, in which each capsule includes substantially the following:

| | | |
|---|---|---|
| (a) | Marine fish of | 850 mg, range 1 mg-999 mg |
| (b) | Total carotenes | 4.10 mg |
| | a. Alpha-carotene | 1.52 mg: range 30 mcg-30 mg |
| | b. Beta-carotene | 2.3 mg: range 45 mcg-45 mg |
| | c. Other carotenes | 280 mcg: range 7 mcg-7 mg |
| (c) | Vitamin E: | 14 mg: range 79 mcg-79 mg |
| | a. Tocopherol | 2.8 mg: range 15 mcg-15 mg |
| | b. Tocotrienols | 11.2 mg: range 64 mcg-64 mg |
| (d) | Other ingredients: | |
| | a. Phytosterols | 1.9 mg: range 38 mcg-38 mg |
| | b. Squalene | 550 mcg: range 11 mcg-11 mg |
| | c. Co-enzyme Q 10 | 200 mcg: range 4 mcg-4 mg |
| | d. Palm oil | 80 mg: range 593 mcg-593 mg |
| (e) | Omega-3 Fatty acids: | 255 mg: range 195 mcg-800 mg |
| | a. Eicosapentaenoic Acid (EPA) | 153 mg: range 100 mcg-800 mg |
| | b. Docosahexanoic Acid (DHA) | 102 mg: range 95 mcg-400 mg. |

19. A food supplement as claimed in claim 1, in which a daily dose of two 1000 mg capsules of the food supplement containing 300 mg Carotino mixed concentrate provides:

| | | |
|---|---|---|
| Alpha-carotene | 3.04 | mg |
| Beta-carotene | 4.6 | mg |
| Other carotenes | 0.6 | mg |
| Tocopherol | 5.6 | mg |
| Tocotrienol | 22.4 | mg |
| Phytosterol | 3.9 | mg |
| Squalene | 1.1 | mg |
| Co-enzyme Q 10 | 400 | mcg |
| Eicosapentaenoic Acid (EPA) | 306 | mg |
| Docosahexanoic Acid (DHA) | 204 | mg. |

20. (canceled)
